(19) United States
(12) Patent Application Publication
(10) Pub. No.: US 2003/0052179 A1
(43) Pub. Date: Mar. 20, 2003

(54) Machine-readable symbol and related method

(76) Inventor: Mark Pinson, Chatsworth, CA (US)

Correspondence Address: Scott W. Kelley, Esq., KELLY BAUERSFELD LOWRY & KELLEY, LLP, Suite 1650, 6320 Canoga Avenue, Woodland Hills, CA, 91367, US

(21) Appl. No.: 10/245,654

(22) Filed: Sep. 16, 2002

Related U.S. Application Data
(60) Provisional application No. 60/322,911, filed on Sep. 17, 2001.

(51) Int. Cl. G06K 19/06

(52) U.S. Cl. 235/494

(57) ABSTRACT

A machine readable symbol includes a rectilinear data field having a plurality of data cells arranged into a matrix. Each data cell is assigned a data pattern value or a finder pattern value. Preferably, at least some of the data cells, or even all of the data cells, include at least one data pattern value and a finder pattern value which are overlapping. A color corresponding to the data pattern value, finder pattern value, or overlapping data pattern value and finder pattern value is assigned to each data cell. A finder pattern is discernable when the symbol is placed under a first color filter or exposed to a first color. A data pattern is discernable when the symbol is placed under a second color filter, or exposed to a second color.

### RELATED APPLICATION

This application claims priority from United States provisional application Serial No. 60/322,911, filed Sep. 17, 2001.

### BACKGROUND OF THE INVENTION

The present invention is generally directed to machine-readable symbols. More particularly, this invention is directed to an identification symbol that can be used on items to be identified and more particularly, to a symbol that includes an orientation finder pattern integrated with data cells and a method for recognizing and decoding the information represented by the symbol.

Machine-readable symbols are well known and commonly used to identify and track products through manufacturing, storage, distribution, and in retail transactions. Probably the best-known example is the use of bar codes to automate checkout and inventory tracking in the grocery store. Traditional bar codes encode characters or digits as patterns of parallel bars of various widths in a single row. Such bar codes, known as “linear bar codes” are scanned and decoded by examining the reflections of the bars along a line roughly perpendicular to the bars of the symbol. The overall width of linear bar code symbols is roughly proportional to the number of characters or digits encoded. However, the linear relationship between the width of the bar code symbol and the data it contains limits the practical data capacity of linear bar code symbols.

Several machine-readable symbols have been introduced which overcome the limited capacity of linear bar codes by representing the encoded data in a two-dimensional matrix pattern. Generally, these two-dimensional symbols graphically represent a binary encoding of the data in contrasting colors —one color for a bit value of ‘1’ and a contrasting color for a bit value of ‘0’. Such “two-dimensional” symbols generally have much higher data densities and capacities than linear bar codes.

In addition to the encoded data, the symbols have other graphic indicia called a “finder pattern” which is used to determine the position and orientation of the data cells. A good finder pattern has characteristics that allow the position and orientation of the data cells to be determined accurately with a minimum amount of computation. However, the need for a finder pattern adds spatial overhead to all known symbols and therefore reduces their data densities.

For several reasons, at the time of decoding, the cells within the symbol matrix may not accurately represent the intended binary pattern. For example, if the symbol is scratched or partly covered with foreign matter the “light cells” may appear to be “dark cells” or vice versa. To allow accurate recovery of the original information when damage occurs to the data cells, known symbols typically include additional information such as Reed-Solomon Error Detection And Correction (EDAC) code words. Inclusion of such EDAC information allows the recovery of the original information so long as the amount of damage does not exceed the error correcting capacity of the EDAC technique employed. However, symbol damage occurring in the finder pattern is not corrected and may render the symbol unreadable (even if there is no damage to the data areas of the symbol) if the damage interferes with the characteristic used to find the symbol. Finder patterns that rely on the detection of small details are more vulnerable to damage because even a small amount of damage may obliterate the detail. Symbols with larger finder patterns can tolerate more finder pattern damage but in all known symbols this increased tolerance comes with the price of lower data density.

Accordingly, there is a continuing need for a machine readable symbol design that allows increased data density and improved tolerance to damage in both the data and finder patterns. There is also a need for a symbol design which increases the error detection and correction capability by providing additional means of recognizing the location of damage. What is further needed is the increase of efficiency and reliability of the finder pattern. Also, means to encode a plurality of messages within the same graphic symbol are needed. The present invention fulfills these needs and provides other related advantages.

### SUMMARY OF THE INVENTION

The present invention resides in a machine readable symbol which fulfills the aforementioned needs and provides benefit over other two-dimensional machine readable symbols. The invention includes the creation of a data field having a plurality of data cells. Typically, the data field is a rectilinear data field. The plurality of data cells are arranged into a matrix.

Each data cell is assigned a data pattern value or a finder pattern value. In a particularly preferred embodiment, at least a subplurality of the data cells have overlapping data pattern values and finder pattern values. In fact, each data cell can be assigned multiple data pattern values. Typically, the data pattern or finder pattern values comprise a binary value, such as a “one” or “zero”.

Each data cell is then assigned a color corresponding to a data pattern value, a finder pattern value or an overlapping data pattern value and finder pattern value. The color may be in the visible or non-visible spectrum. A finder pattern is discernable when the symbol is placed under a first color filter, or exposed to a first color. A data pattern is discernable when the symbol is placed under a second color filter or exposed to a second color. In the case of multiple data patterns, yet a third color can be used to reveal the data pattern.

Other features and advantages of the present invention will become apparent from the following more detailed description, taken in connection with the accompanying drawing which illustrate, by way of example, the principals of the present invention.

### BRIEF DESCRIPTION OF THE DRAWINGS

The accompanying drawings illustrate the invention. In such drawings:

FIG. 1 illustrates a rectilinear data field;

FIG. 2 illustrates the assignment of data pattern binary values to data cells within the field;

FIG. 3 illustrates the assignment of finder pattern binary values to the data cells;

FIGS. 4A-4C illustrate bar widths measured as a scan line passes through the center of the finder pattern;

FIG. 5 illustrates a function used to determine cell color from the values of the data pattern and the values of the finder pattern;

FIG. 6 illustrates the assignment of cell colors in the resultant symbol;

FIG. 7 illustrates the appearance of the symbol when illuminated with red light; and

FIG. 8 illustrates the appearance of the symbol when illuminated with green light.

### DETAILED DESCRIPTION OF THE PREFERRED EMBODIMENTS

The present invention resides in a system that captures an image of a two-dimensional machine readable symbol 10 having a data pattern and finder pattern to enable determination of symbol orientation, as well as the decoding of the contents of the symbol 10 so as to output the decoded contents of the symbol 10 to a display reader device (not shown). The present invention is intended to increase data density and improve tolerance to damage in both data and finder patterns. Error detection and correction capability of the symbol is increased by providing additional means of recognizing the location of damage. Further, efficiency and reliability of the finder pattern is increased.

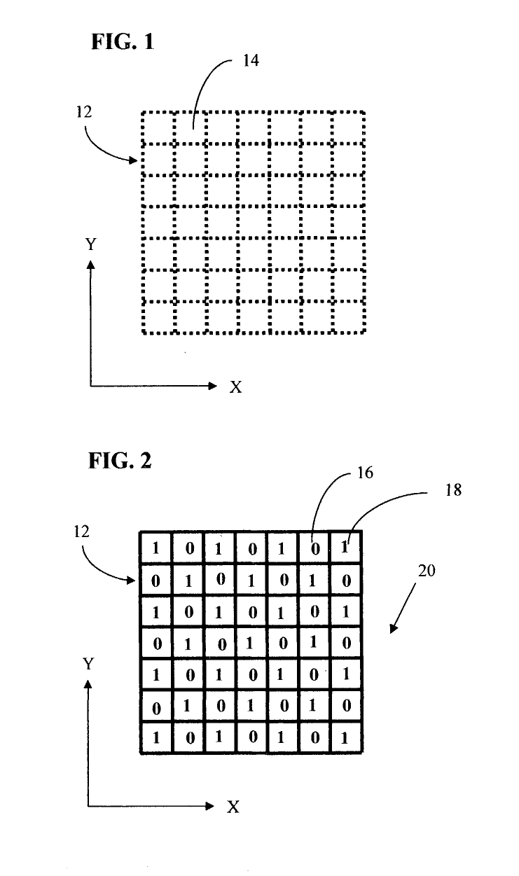

With reference now to FIG. 1, a symbol 10 is comprised of a rectilinear data field 12 having a plurality of data cells 14 arranged in a matrix. A 7 by 7 matrix is illustrated, although it will be appreciated by those skilled in the art that the size of the matrix and the number of data cells can be varied in order to achieve the same results. As shown by the x and y coordinates, the symbol 10 is a two-dimensional rectilinear data field 12.

With reference now to FIG. 2, binary data 16 and 18, such as “zero” and “one” are assigned to each data cell. The mapping of this binary data 16 and 18 creates a data pattern. As illustrated in FIG. 2, the binary data 16 and 18 consist of 49 alternating ones and zeros mapped into the 7 by 7 data field matrix. Of course, other data patterns can be created such that the binary data is not alternating, but forms another pattern. Each data cell 14 need not necessarily be assigned a binary value 16 or 18. In fact, two distinct data patterns could be created in the illustrated matrix by assigning a sub-plurality of the data cells 14 a first pattern, and a second sub-plurality of data cells another data pattern. Alternatively, each data cell could be assigned a different binary data value so that the data patterns are in effect overlapping.

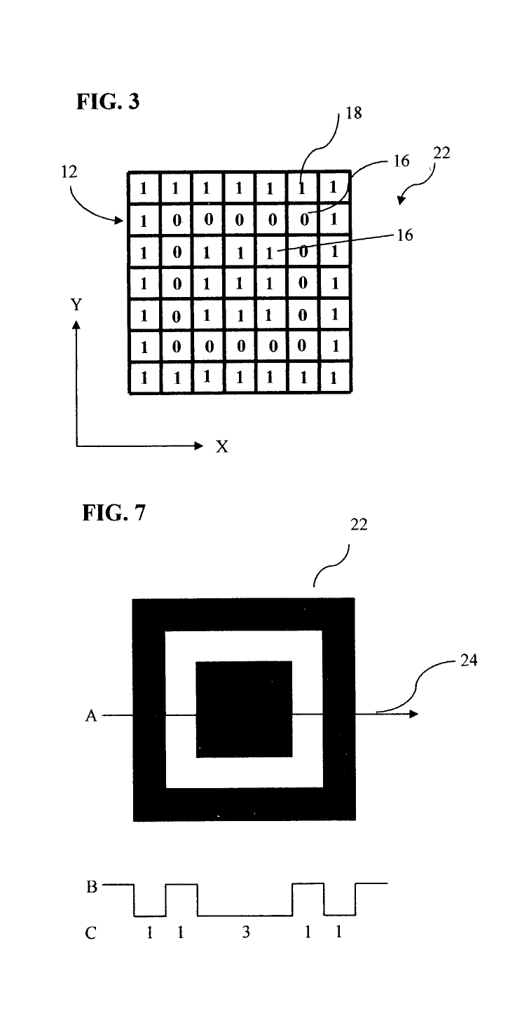

With reference now to FIG. 3, a finder pattern 22 is illustrated and comprised of the assignment of the binary data in the form of ones and zeros to the data cells 14. As illustrated in FIG. 3, this particular finder pattern consists of three concentric squares of alternating values mapped onto the 7 by 7 matrix data field 12. A 3 by 3 block of data cells are assigned a “one” value, data cells surrounding this block are assigned a “zero”, and the outermost data cells 14 are again assigned a “one”. Thus, the illustrated finder pattern 22 comprises three concentric squares of 3 by 3, 5 by 5, and 7 by 7, from smallest to largest. Of course, those skilled in the art will appreciate that other finder patterns may be created by altering the assignment of the binary data to the individual data cells 14. Also, although each data cell 14 is illustrated as being assigned a binary value, it should be understood by the reader that not necessarily all of the data cells 14 need be assigned a finder pattern value. However, in a particularly preferred embodiment, at least some of the data cells 14 will be simultaneously assigned a binary data value and a binary finder value so that informational density is increased.

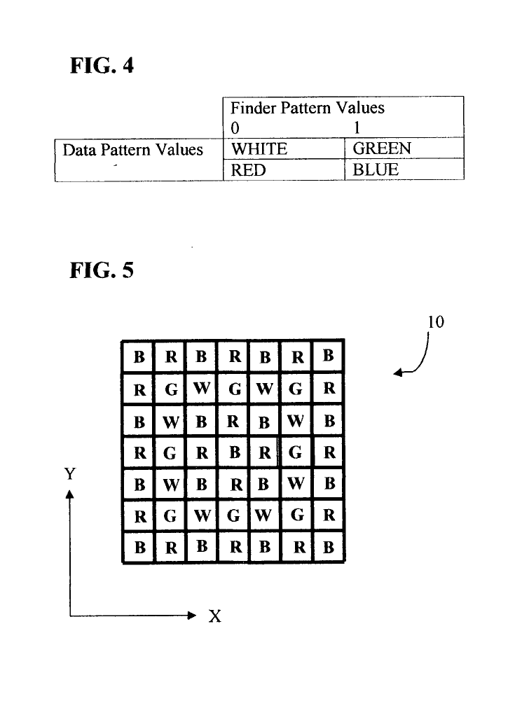

To create the graphic symbol 10, the finder pattern 22 and data pattern 20 are superimposed using a color assignment function. Such a color assignment function is illustrated in FIG. 4. The data cells 14 of the symbol 10 are assigned color values based on the values of the corresponding location and the data and the finder pattern binary maps. As illustrated, a data cell having a binary value of “zero” for both the data pattern value and finder pattern value is assigned the color white. A data cell 14 having a binary data value of “zero” for the data pattern, yet a binary data value of “one” for the finder pattern value is assigned the color green. A data cell 14 having a binary data pattern value of “one” and a finder pattern value of “zero” is assigned the color red. Lastly, in this example, a data cell 14 having a data pattern value of “one” and a finder value pattern of “one” is assigned the color blue. A resultant graphic symbol 10 produced using the colors determined by this function is illustrated in FIG. 5 (B =Blue; R=Red; G=Green and W=White). Of course, a different resulting graphic symbol would be produced using different data patterns and finder patterns, or a different function for assigning color.

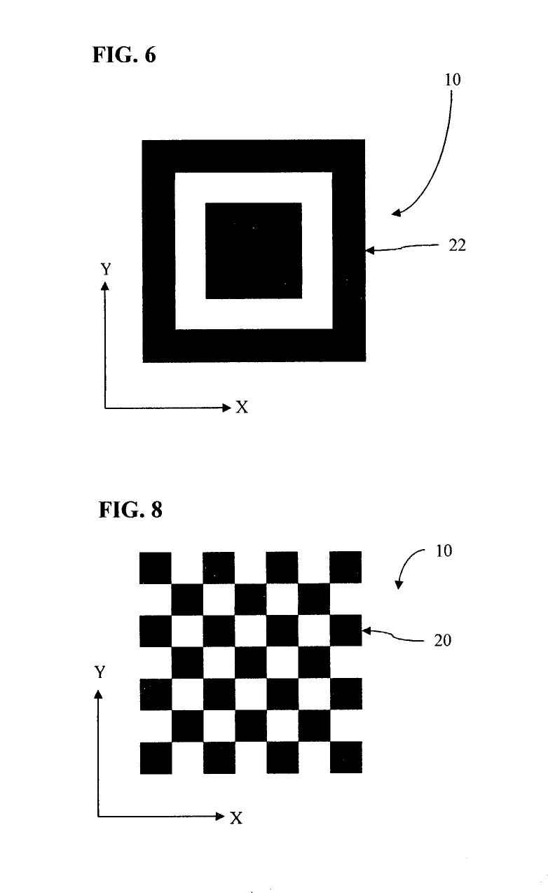

When viewed undergreen illumination, or through a green color filter, the symbol 10 appears as illustrated in FIG. 6 and a finder pattern 22 becomes visible. During reading, this finder pattern 22 is located by passing a scan line 24 across the center of the finder pattern 22 or symbol 10 and detecting bar thickness ratios of 1:1:3:1:1, as depicted in FIGS. 4 A-C.

With reference now to FIG. 8, when the symbol 10 is exposed to red illumination or viewed through a red color filter, the symbol 10 appears as illustrated and reveals the binary state of the data cells 14 to reveal the data pattern 20. Thus, in the illustrated preferred embodiment, the finder pattern 22 occupies the same space as the data 20 itself, adding no spacial overhead.

It will be obvious to those skilled in the art that the input to the color assignment function could include two or more data patterns in addition to a finder pattern. This would allow the symbol 10 to encode alternative messages for different purposes and support authentication. The assigned “colors” could be outside of the visible range, yet still readable by the machine.

As mentioned above, it will be readily apparent to those skilled in the art that the symbol 10 could be rendered with different color assignment functions than that used in the foregoing description of the preferred embodiment, nor is the present invention limited to the particular finder pattern or matrix size described above.

The finder pattern 22, as in the foregoing illustrated and described example, may be as large as the total data area 20 thus maximizing the reliability of accurately finding the symbol 10. Moreover, symbol damage is unlikely to change a data cell 14 from its intended state to the color of its opposite state as frequently occurs in primary or prior art binary data encoded as light or dark areas. For example, if the value states of the given cell are green and red, then the existence and location of damage that resulted in any other colors could be determined during image processing. The prior knowledge of the location of damage greatly enhances and extends commonly known EDAC technique such as Reed-Solomon encoding.

Although several embodiments of the present invention have been described in detail for purposes of illustration, various modifications of each may be made without departing from the spirit and scope of the invention. Accordingly, the invention is not to be limited, except as by the appended claims.

What is claimed:

1. A machine readable symbol, comprising:
a data field comprised of a plurality of data cells, each data cell being assigned a color corresponding to a data pattern value, a finder pattern value or an overlapping data pattern value and finder pattern value;
wherein a finder pattern is discernable when the symbol is placed under a first color filter or exposed to the first color, and a data pattern is discernable when the symbol is placed under a second color filter or exposed to the second color.

2. The symbol of claim 1, wherein the data field is a rectilinear data field.

3. The symbol of claim 1, wherein the plurality of data cells are arranged into a matrix.

4. The symbol of claim 1, wherein each data cell is assigned a color corresponding to an overlapping data pattern value and finder pattern value.

5. The symbol of claim 1, wherein the color assigned to each data cell is either in the visible or non-visible spectrum.

6. The symbol of claim 1, wherein each data cell is assigned a color corresponding to a finder pattern value and multiple data pattern values.

7. The symbol of claim 1, wherein the data pattern value comprises a one or a zero in at least a subplurality of the data cells.

8. The symbol of claim 1, wherein the finder pattern value comprises a one or a zero in at least a subplurality of the data cells.

9. A machine readable symbol, comprising:
a rectilinear data field comprised of a plurality of data cells arranged into a matrix, each data cell being assigned a color corresponding to a data pattern value,. a finder pattern value or an overlapping data pattern value and finder pattern value;
wherein a finder pattern is discernable when the symbol is placed under a first color filter or exposed to the first color, and a data pattern is discernable when the symbol is placed under a second color filter or exposed to the second color.

10. The symbol of claim 9, wherein each data cell is assigned a color corresponding to an overlapping data pattern value and finder pattern value.

11. The symbol of claim 9, wherein the color assigned to each data cell is either in the visible or non-visible spectrum.

12. The symbol of claim 9, wherein each data cell is assigned a color corresponding to a finder pattern value and multiple data pattern values.

13. The symbol of claim 9, wherein the data pattern value comprises a one or a zero in at least a subplurality of the data cells.

14. The symbol of claim 9, wherein the finder pattern value comprises a one or a zero in at least a subplurality of the data cells.

15. A method for creating and reading a machine readable symbol, comprising the steps of:
creating a data field having a plurality of data cells;
assigning a data pattern value to each data cell;
assigning a finder pattern value to at least some of the data cells;
assigning a color to each data cell, the color corresponding to the data pattern value, the finder pattern value, or an overlapping data pattern value and finder pattern value;
positioning the symbol under a first color filter or exposing the symbol to a first color to discern a finder pattern; and
positioning the symbol under a second color filter or exposing the symbol to a second color to discern a data pattern.

16. The method of claim 15, wherein the creating step includes creating a rectilinear data.

17. The method of claim 16, wherein the plurality of data cells are arranged into a matrix.

18. The method of claim 15, wherein the assigning color step comprises assigning a color in the visible or non-visible spectrum.

19. The method of claim 15, wherein the assigning data pattern value step comprises assigning either a one or a zero to at least a subplurality of data cells.

20. The method of claim 15, wherein the assigning finder pattern value step comprises assigning either a one or a zero to at least a subplurality of data cells.
